(19) United States
(12) Patent Application Publication
(10) Pub. No.: US 2024/0367412 A1
(43) Pub. Date: Nov. 7, 2024

(54) COMPRESSION MEMBERS

(71) Applicant: CREATIVE PULTRUSIONS, INC., Alum Bank, PA (US)

(72) Inventors: Jeremy D. MOSTOLLER, Johnstown, PA (US); Daniel E. WINEY, Port Matilda, PA (US); Dustin L TROUTMAN, Hopewell, PA (US)

(21) Appl. No.: 18/552,840

(22) PCT Filed: Apr. 4, 2022
(86) PCT No.: PCT/US2022/071521

§ 371 Date: Sep. 27, 2023

Related U.S. Application Data
(60) Provisional application No. 63/170,197, filed on Apr. 2, 2021.

(51) Int. Cl. B32B 5/26; B29D 23/00; B32B 1/08; B32B 5/02; B32B 7/12; B32B 37/12; B32B 38/00

(52) U.S. Cl. CPC B32B 5/26; B29D 23/00; B32B 1/08; B32B 5/02; B32B 7/12; B32B 37/1284; B32B 38/0012; B32B 2037/1253; B32B 2038/0076; B32B 2250/20; B32B 2262/101; B32B 2305/72; B32B 2307/7375; B32B 2597/00

(57) ABSTRACT

A compression member comprising a plurality of nested pultruded segments.

### CROSS-REFERENCE TO RELATED APPLICATIONS

This application is an International application filing which claims priority to U.S. Provisional Patent Application Ser. No. 63/170,197 filed Apr. 2, 2021, the disclosures of which are incorporated herein by reference.

### BACKGROUND

Industries across the world are moving towards using composite materials for construction and manufacturing. One such material is fiber reinforced plastic (FRP), which is efficient to manufacture and has good strength and durability characteristics. FRP is advantageous over metal materials, such as aluminum or steel, in that it is highly resistant to both corrosion, and less expensive. In addition, FRP is easy to install, and thus a cost effective option. FRP is made via a pultrusion process, and may be formed in various shapes and sizes depending on a particular end use application. For example, FRP may be formed in the shape of beam segments of various cross sectional shapes, and or of angle sections, etc. Due to the increasing popularity of FRP and its ever advancing use into new construction applications, a need exists for FRP members having enhanced strength.

### SUMMARY OF DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to one embodiment of the present disclosure, a compression member is described. The compression member includes a core and a plurality of nested outer portions laminated there over. In one further embodiment, the nested outer portions include a first outer portion having a first sidewall defining a hollow interior configured to nest the core and a second outer portion having a second sidewall defining a second hollow interior configured to nest the first outer portion. In another further embodiment, the nested outer portions further include a third outer portion having a third sidewall defining a third hollow interior configured to nest the second outer portion. In another further embodiment, the compression member includes an adhesive in bonding contact between the core and each nested outer portions. In another further embodiment, the core is a hollow bore. In another further embodiment, the compression member has one of a circular cross-section and circular cross-section. In another further embodiment, the core and nested outer portions are composed of pultruded fiberglass. In another further embodiment, the compression member has a length from about 12 inches to about 108 inches.

In accordance with another exemplary embodiment of the present disclosure, a method for manufacturing a compression member is described. The method includes pultruding a length of a core, pultruding a first outer portion having a first sidewall defining a hollow interior configured to receive the core, pultruding a second outer portion having a second sidewall defining a second hollow interior configured to receive the first outer portion, nesting the core into the hollow interior of the first outer portion, and nesting the first outer portion into the second hollow interior of the first outer portion. In a further embodiment, the method includes pultruding a third outer portion having a third sidewall defining a third hollow interior and nesting the second outer portion in the third hollow interior. In another further embodiment, the method further includes before nesting, roughing an outer surface of the core, first outer portion, and second outer portion. In another further embodiment, the method further includes before nesting, applying an adhesive to one of an outside surface of a core and interior hollow surface of an outer portion. In another further embodiment, the method further includes after nesting, injecting adhesive into gaps formed between adjacent core and outer portions. In another further embodiment, the method further includes curing the adhesive. In another further embodiment, curing the adhesive includes application of a temperature from about 100 degrees Celsius to about 200 degrees Celsius.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 illustrates an example bridge structure that may incorporate the principles of the present disclosure.

FIG. 2A is a cross-sectional end view of a compression member that may be utilized in the bridge of FIG. 1.

FIG. 2B is a perspective view of the compression member of FIG. 2A.

FIG. 2C illustrates an partially exploded view of the compression member of FIG. 2A.

FIG. 3 is a cross-sectional end view of an alternate compression member that may be utilized in the bridge of FIG. 1.

FIG. 4 is a graph of compressive load versus overall head deformation for 36 inch length compression members of Example 1.

FIG. 5 is a graph of compressive load versus overall head deformation for 72 inch length compression members of Example 1.

### DETAILED DESCRIPTION

The present disclosure is related to compression members composed of a composite material and, more particularly, to composite compression members that can be used in various load bearing applications. The composite material may be Fiber Reinforced Plastic (FRP). The FRP compression members and components thereof described herein may be manufactured by pultrusion processes. As one illustrative example, a pultrusion process includes pulling a reinforcing material impregnated with a heat curable thermosetting polymeric composition through a temperature controllable pultrusion die.

The embodiments described herein provide a pultruded FRP compression member made of nested FRP members integrally connected to one another.

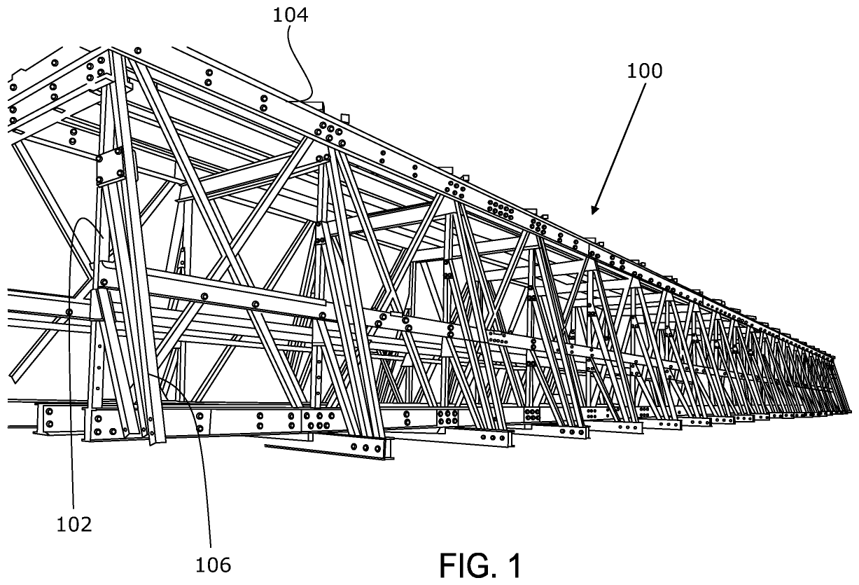

FIG. 1 illustrates an example end use application where embodiments of the present disclosure may be utilized. In particular, FIG. 1 illustrates an example bridge 100 constructed from various FRP structural members, including members under tension, members under compression, and members subject to torsion, which all cooperate together to provide the bridge 100 with its load bearing capabilities. These FRP structural members include interior vertical columns 102, longitudinal members 104, angled outrigger member 106, among others. Here, the interior vertical columns 102 extend vertically between top and bottom longitudinal members 104, which are channels sandwiching opposite ends of the compression members, and the bridge 100 is designed such that vertical columns are in compression (i.e., compression members).

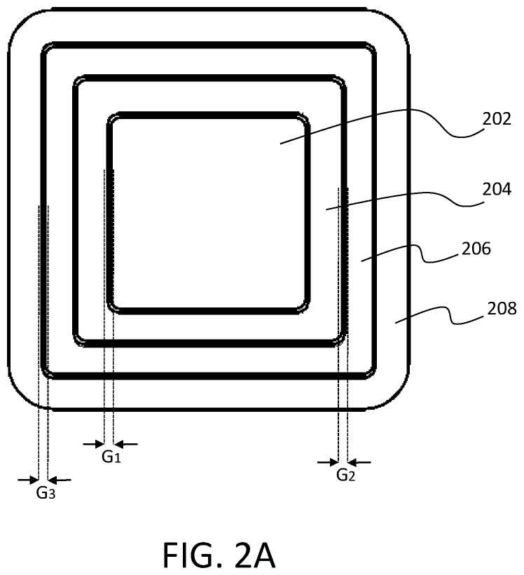

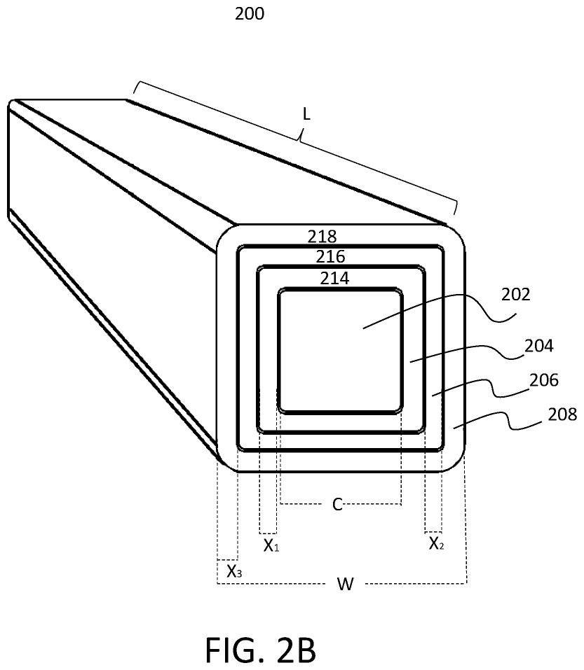

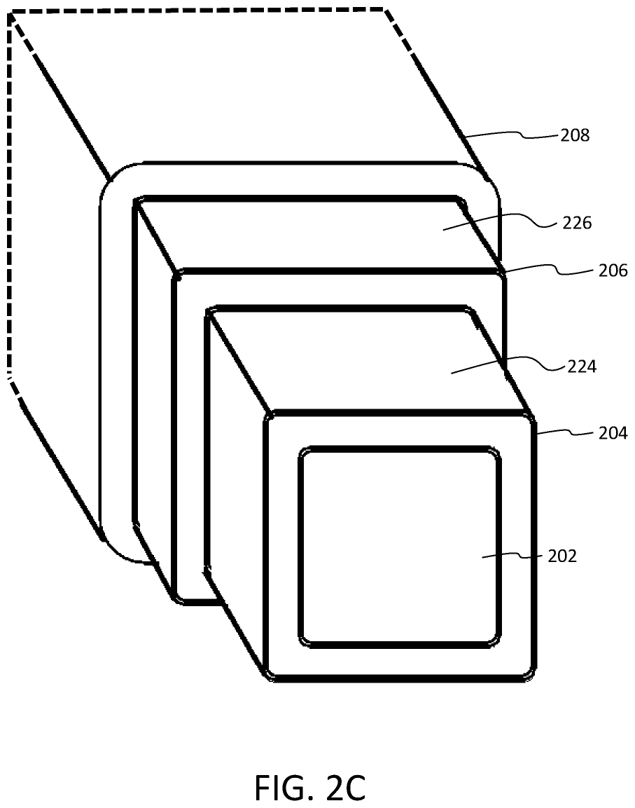

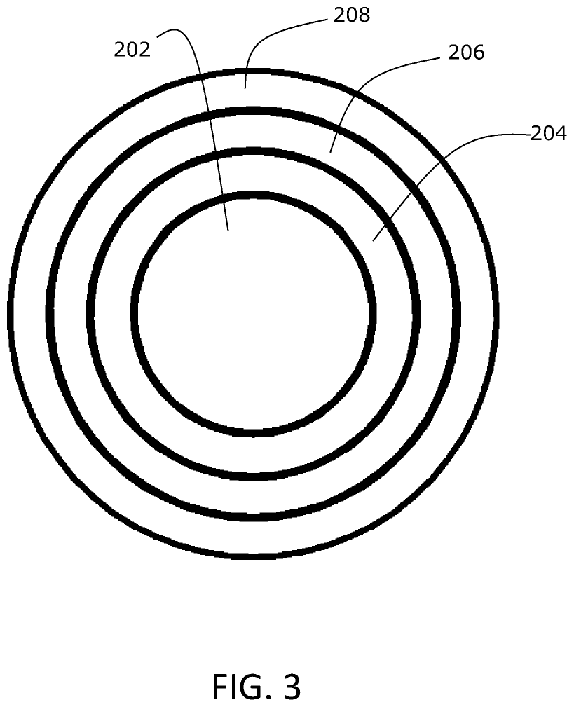

FIGS. 2A and 2B illustrates a cross-sectional view and a perspective view, respectively, of a compression member 200, according to one or more embodiments of the present disclosure. While FIGS. 2A and 2B illustrate the compression member 200 having a generally square shaped geometry when evaluated in cross-section, it may have other shapes or geometries. For example, the compression member 200 may have a generally circular shaped geometry when evaluated in cross-section, as exemplified in FIG. 3. The compression member 200 may be manufactured to any length L, for example, the compression member 200 may have a length of 36 inches, 72 inches, etc. In some embodiments, the compression member 200 has a length from about 12 inches to about 108 inches (9 feet).

In the illustrated examples, the compression member 200 includes an inner core 202 and a plurality of outer portions arranged concentrically about the inner core 202. That is, the outer portions include a first portion 204 adjacent to the core 202, a second portion 206 between the first and third portions, and a third outermost portion 208, such that, at least in the illustrated example, the compression member 200 comprises four (4) discrete nested parts. It is to be appreciated that the number of nested parts is not limiting and that the compression member 200 may comprise more or less than the illustrated three (3) nested outer portions 204, 206, 208 arranged about the core 202. In the exemplary embodiment of FIGS. 2A-2B, the core 202 is a solid pultruded piece having a length L (i.e., not hollow). In other embodiments, the core 202 may be hollow and define a bore of various cross-sectional geometries, such as a circular geometry or a geometry matching cross-section of the outer portion outer surface.

The compression member 200 has a width W corresponding the width of the outermost outer portion 208. The width W may vary depending on the end use application and thus, is not limiting. However, in some embodiments, the width W is between 2 inches and about 10 inches. In a further embodiment, the width W is about 3 inches to about 5 inches.

The size of the core 202 may also vary with application. In some embodiments, the core 202 has a width C that from about 1 inch to about 3 inches. In some embodiments, the modulus of the core 202 is different from the modulus of the outer portions. That is, the modulus of the core 202 is greater than or less than the modulus of each of the individual outer portions 204, 206, 208 such that the core 202 is dissimilar from the outer portions.

Each outer portion 204, 206, 208, includes a sidewall 214, 216, and 218 of thickness X₁, X₂, X₃, respectively, that defines a hollow interior sidewall surface configured receive and bond to an outer sidewall surface of an adjacent nested member. For example, outer portion 204 having sidewall 214 includes a hollow interior configured to revive the entirety of the core 202. Likewise, outer portion 206 having sidewall 216 includes a hollow interior area configured to receive the entirety of outer portion 204, and so on. The width X₁, X₂, X₃, of each sidewall 214, 216, 218, respectively, may vary with application. In some embodiments, the sidewall width ranges from about 0.25 inch to about 1 inch. The width X₁, X₂, X₃ of each sidewall may be the same (X₁=X₂=X₃) or the width of each may be different. For example, sidewall width X₁, X₂, X₃ of each portion 204, 206, 208, respectively, may increase or decrease with respect to its position from the core 202. As noted above the modulus of each individual outer portion 204, 206, 208, is different from the core 202. In some embodiments, the modulus of each outer portion 204, 206, 208 increases/decreases with respect to its position in the nested assembly from the core 202.

As briefly noted above, the core 202 and the outer portions 204, 206, 208 nestedly arranged therein, may be formed via a pultrusion process. For example, each of the four (4) nested components of the compression member 200 may be pultruded fiberglass components secured together via an adhesive. In some embodiments, the hollow interior area of each outer portion has a diameter (width) that is larger than the outer diameter (width) of the outer portion or core 202 configured for insertion therein. In other words, in some embodiments, there is a gap G₁ between the outer surface of the core 202 and the interior surface of the first outer portion 204, and a gap G₂ between the outer surface of first outer portion 204 and the interior surface of the second outer portion 206, and a gap G₃ between the outer surface of second outer portion 206 and the interior surface of the outermost outer portion 208, that provides space that accommodates an adhesive material to fill and bond the portions and core together. In some embodiments, the gap G is between adjacent portions is from about 0.005 inches to about 0.030 inches.

In some embodiments an outer surface of the core 202 and outer surface of the outer portions 204, 206, may be prepared for bonding. This may include roughing the outer surface with a grit material (e.g., sandpaper) to remove residual mold release agents, dirt, etc. In some further embodiments, the outer surfaces are roughed with an 80 grit sand paper prior to application of an adhesive. In some embodiments, the inner bore surface area of the outer portions are similarly prepared for bonding.

In some embodiments, the outer surface of the inner core 202 may be treated and then smeared with an adhesive. Then the first outer portion 204 may be slid over the adhesive covered inner core 202. It is to be appreciated that the location of application of adhesive is not limiting and that adhesive may instead be smeared over an inner bore surface of the first outer portion, or adhesive may be provided on both the core's 202 outer surface and the inner bore surface of the outer portion 204. The outer portion 204 may be a similar pultruded fiberglass component with the outer surface 224 treated and covered with adhesive wherein the second outer portion 206 may be slid over the first portion 204. Again, the adhesive may instead be smeared over an inner bore surface of the second outer portion 206, or adhesive may be provided on both the first portion's 204 outer surface 224 and the inner bore surface of the second outer portion 206. The outer portion 206 may also be a pultruded fiberglass component similarly treated and covered with adhesive over an outer surface 226 thereof. The third outermost portion 208 (which may also be a pultruded fiberglass component) may be slid over the second outer portion 206. Again the location of the application of adhesive is not limiting and adhesive may instead be smeared over an inner bore surface of the third outer portion 208, or adhesive may be provided on both the second outer portion's 206 outer surface 226 and the inner bore surface of the third outer portion 208). In some exemplary embodiments, the adhesive holding the four (4) nested components of the compression member 200 is a polyurethane based adhesive.

In some exemplary embodiments, rather than directly covering the core 202 and outer portions 204, 206, 208 with adhesive and joining the various components via sliding engagement, the core 202 and outer portions 204, 206, and 208 may be nested together as shown in FIGS. 2A-C and adhesive material may be injected into the gaps G₁, G₂, G₃ between adjacent portions. That is, a pressure injection system may push adhesive between adjacent portions allowing the adhesive to flow in gaps along the length of the compression member.

The adhesively nested core 202 and outer portions 204, 206, and 208 may be cured such that the adhesive bonds adjacent members together. In some embodiments, heat is applied to the nested components in order to cure the adhesive. The temperature range applied for curing the adhesive ranges from about 100 degrees Celsius to about 200 degrees Celsius. Bonds formed using hear curing urethane adhesives have high strength but maintain some elastic properties.

In some embodiments, the nested core 202 and outer portions 204, 206, and 208 are nested together without an adhesive bonding each adjacent section. In some embodiments, some potions are adhesively bonded while others are not. For example and without limitation, the core 202 may be nested within outer portion 204 without adhesive there between while outer portion 204 may be adhesively bonded with outer portion 206 which may or may not be adhesively bonded to outer portion 208.

The compression member 200 comprised of discrete nested components adhesively bonded together provides surprising enhanced strength compared to theoretical models of the same. Table 1 below, illustrates predictive calculated load values based on Euler Buckling Models versus actual test data of nested compression members having 6 feet and 9 feet lengths. The tested profiles includes a 3 inch wide with a 0.25 inch wall tube, a 2.47 inch wide with a 0.22 inch wall tube, a 2 inch wide with a 0.25 inch wall tube, and 1.47 inch solid core. A conservative K-factor of 0.65 was used in theoretical modeling. As illustrated in Table 1, the actual test values greatly exceed the calculated load values having a percent difference of about 48%.

TABLE 1
Calculated vs Actual Load Values

| Compression | Predicted | Average Test | |
|---|---|---|---|
| Member Length, | Value* | Value | Percent |
| ft. | (lbf) | (lbf) | difference |
| 6 | 105.0 | 172.9 | 48.8% |
| 9 | 50.3 | 81.7 | 47.9% |

The following examples are provided to illustrate the articles, devices and processes of the present disclosure. The examples are merely illustrative and are not necessarily intended to limit the disclosure to the materials, conditions, or process parameters set forth therein.

### EXAMPLE 1

3.0 in square cross-section compression members were constructed in three different nominal heights (lengths) of 12.0, 36.0, and 72.0 inches. Specimen ends were wrapped with 4.0 in wide unidirectional glass FRP sheets at the ends to provide confinement and avoid premature failure at the ends due to potential stress concentration. Specimens were tested in universal test frames meeting ASTM E4-20 (Standard Practices for Force Verification of Testing Machines) and ASTM E21309-20 (Standard Practices for Verification of Displacement Measuring Systems and Devices Used in Material Testing Machines). Specimens were loaded under displacement control conditions at a rate of 2.5 mm/min (0.10 in./min). Specimens were tested until compressive failure was reached. Results below represent the load-displacement performance of Fiber Reinforced Polymer (FRP) vertical column specimens under direct uni-axial compressive stress.

TABLE 2
Peak Compressive Load of Compression Members

| | | Adhesive | Peak Load | Peak Load |
|---|---|---|---|---|
| Ref. | Length (in.) | Application | kN | kip |
| 1 | 12 | Injected | 2397.6 | 539.0 |
| 2 | 12 | Injected | 2264.3 | 509.0 |
| 3 | 12 | Injected | 2172.5 | 488.4 |
| Average | | | 2278.1 | 512.1 |
| 4 | 12 | Smeared | 1788.5 | 402.1 |
| 5 | 12 | Smeared | 1757.1 | 395.0 |
| 6 | 12 | Smeared | 1975.0 | 444.0 |
| Average | | | 1840.2 | 413.7 |
| 7 | 36 | Injected | 1623.9 | 365.1 |
| 8 | 36 | Injected | 1611.8 | 362.3 |
| 9 | 36 | Injected | 1624.9 | 365.3 |
| Average | | | 1620.2 | 364.2 |
| 10 | 36 | Smeared | 1521.7 | 342.1 |
| 11 | 36 | Smeared | 1533.5 | 344.7 |
| 12 | 36 | Smeared | 1221.6 | 274.6 |
| Average | | | 1425.6 | 320.5 |
| 13 | 72 | Injected | 665.4 | 149.6 |
| 14 | 72 | Injected | 611.6 | 137.5 |
| 15 | 72 | Injected | 624.2 | 140.3 |
| Average | | | 633.7 | 142.5 |
| 16 | 72 | Smeared | 684.6 | 153.9 |
| 17 | 72 | Smeared | 697.4 | 156.8 |
| 18 | 72 | Smeared | 679.9 | 152.8 |

| | | |
|---|---|---|
| Average | 687.3 | 154.5 |

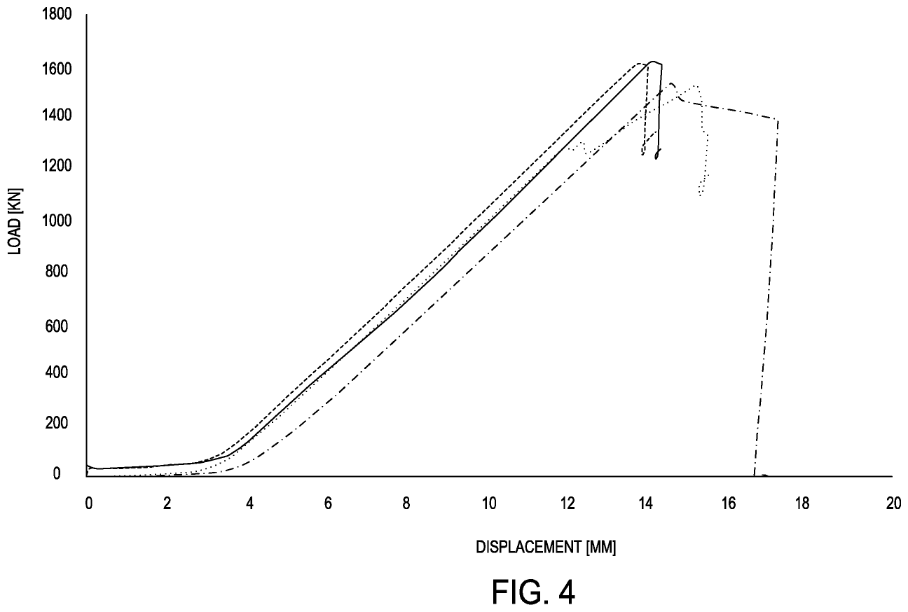

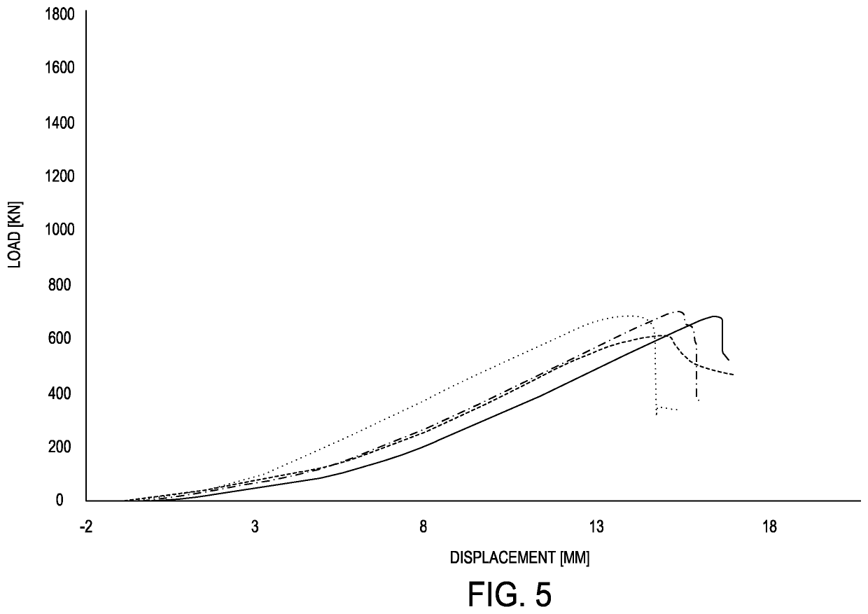

FIG. 4 is a graph illustrating Displacement versus Load for 36 inch lengths. Reference 7 is illustrated with the solid line; Reference 8 is illustrated with the dashed line; Reference 10 is illustrated with the dotted line; and, Reference 11 is illustrated with the dot-dash line. FIG. 5 is a graph illustrating Displacement versus Load for 72 inch lengths. Reference 13 is illustrated with the solid line; Reference 14 is illustrated with the dashed line; Reference 16 is illustrated with the dotted line; and, Reference 17 is illustrated with the dot-dash line.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The terms “proximal” and “distal” are defined herein relative to an end user holding or manipulating the compression member. The term “proximal” refers to the position of an element closer to the end user and the term “distal” refers to the position of an element further away from the end user. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A compression member, comprising:
a core and a plurality of nested outer portions arranged concentrically with the core.

2. The compression member according to claim 1, wherein the nested outer portions comprise: a first outer portion having a first sidewall defining a hollow interior configured to nest the core; and a second outer portion having a second sidewall defining a second hollow interior configured to nest the first outer portion.

3. The compression member according to claim 2, wherein the nested outer portions further comprise a third outer portion having a third sidewall defining a third hollow interior configured to nest the second outer portion.

4. The compression member according to claim 1, further comprising an adhesive in bonding contact between the core and each nested outer portions.

5. The compression member according to claim 1, wherein the core is a hollow bore.

6. The compression member according to claim 1, wherein the compression member has one of a circular cross-section and circular cross-section.

7. The compression member according to claim 1, wherein the core and nested outer portions are composed of pultruded fiberglass.

8. The compression member according to claim 1, the compression member having a length from about 12 inches to about 108 inches.

9. A method for manufacturing a compression member comprising:
pultruding a length of a core;
pultruding a first outer portion having a first sidewall defining a hollow interior configured to receive the core;
pultruding a second outer portion having a second sidewall defining a second hollow interior configured to receive the first outer portion;
nesting the core into the hollow interior of the first outer portion; and
nesting the first outer portion into the second hollow interior of the first outer portion.

10. The method according to claim 9, further comprising:
pultruding a third outer portion having a third sidewall defining a third hollow interior;
nesting the second outer portion in the third hollow interior.

11. The method according to claim 9, further comprising
before nesting, roughing an outer surface of the core, first outer portion, and second outer portion.

12. The method according to claim 9, further comprising:
before nesting, applying an adhesive to one of an outside surface of a core and interior hollow surface of an outer portion.

13. The method according to claim 9, further comprising:
after nesting, injecting adhesive into gaps formed between adjacent core and outer portions.

14. The method according to claims 9 and 10, further comprising:
curing the adhesive.

15. The method according to claim 14, wherein curing the adhesive includes application of a temperature from about 100 degrees Celsius to about 200 degrees Celsius.
